(19) United States
(12) Patent Application Publication
(10) Pub. No.: US 2007/0005541 A1
(43) Pub. Date: Jan. 4, 2007

(54) Methods for Validation and Modeling of a Bayesian Network

(75) Inventors: Sarmad Sadeghi, Houston, TX (US); Afsaneh Barzi, Houston, TX (US); Navid Sadeghi, Houston, TX (US)

Correspondence Address: SARMAD SADEGHI, 2608 TALBOTT ST., HOUSTON, TX, 77005, US

(73) Assignee: Sarmad Sadeghi, Houston, TX (US)

(21) Appl. No.: 10/908,896

(22) Filed: May 31, 2005

(51) Int. Cl. G06N 5/00

(52) U.S. Cl. 706/45

(57) ABSTRACT

This invention patent application describes mathematical methods to evaluate and validate the numbers in the conditional probability tables of a Bayesian network. Using the methods described here, the nodes of interest in the network could be evaluated for validity of the information they contain and errors could be detected by domain experts or knowledge engineers very easily. If there is a disagreement between knowledge engineers or domain experts belief of what the interaction should be and what is detected in the behavior of nodes selected for validation as shown in the reports, then, those errors could be easily located in the structure of the Bayesian network by pin pointing the table, column and row of the problematic cell. Then, the knowledge engineer or domain expert could modify the numbers to reflect the correct behavior. These methods also provide significant insight into the structure and efficiency of the structural design of the Bayesian network as well as value of information in the network. Using this information, hypothesis oriented application of Bayesian network is possible and evidence most relevant to the hypothesis of interest could be instantiated first. Additionally, the shortest path to rule-out or rule-in of a hypothesis could be known before the network is used. Applications of these methods in computer software could allow for streamlined and semi-automated design and validation process and construction of Bayesian networks. Furthermore, by using an almost reverse process, information about a domain can be captured and sorted lists prepared which in turn will be used to prepare a preliminary Bayesian network. Data elicitation using the network created in this fashion will complete the structure and probability tables of the Bayesian network.

### FIELD OF THE INVENTION

This invention relates generally to probabilistic decision modeling and more particularly to decision modeling and decision support using Bayesian networks in medical sciences.

### DISCUSSION OF PRIOR ART

A Bayesian network comprises of nodes that describe evidence and hypotheses in a domain; these nodes are connected to one another to further define the interactions in the domain. Additionally, nodes contain tables which represent knowledge regarding these interactions.

Validating a Bayesian network by enumerating all realizations of the sample space can be prohibitively time consuming, since the combinatorial burden for all possible combinations of findings in the domain ranges from 10¹⁰ for a smaller network, to over 10¹⁵ for a larger network with less than 100 nodes. At a speed of 1 millisecond per combination, validation of these networks takes between 3.5 months for the smaller sizes to 322 centuries for larger networks.

The purpose of this invention is to provide validation techniques to ensure the integrity of the Bayesian network in a reasonable amount of time without the need to enumerate all possible combinations and outcomes. At the same time, methods provided here have sufficient depth to examine segments of these large combinatorial spaces and show that adding evidence from a certain point onward does not change the outcome and therefore, enumeration of that space will be of low yield. Furthermore, this invention provides new insight into construction of a Bayesian network by reversing the validation method.

Considerable progress has been made in recently in Bayesian networks, as described in Pearl (1988), Spiegelhalter, D. and Dawid, et al (1993), Jensen and Lauritzen (2000), etc. As the size of a Bayesian network grows, many approximation and computation techniques have been developed to facilitate evidence propagation, described or summarized by Agogino (1998), Heckerman and Horvitz (1987), Druzdzel and van der Gaag (1995), Jaakkola and Jordan (1996), Jensen (1990, 1995), and many others. However, an overall approach to validate all aspects of domain modeling for a Bayesian networks has not been put forth.

Heckerman in U.S. Pat. No. 5,802,256 describes an improved belief network generator. Heckerman's invention takes a prior belief network (“prior network”) and using cases (or instances of the domain) built from empirical data, acquired, for instance, from service log at a service station, invokes the network generator of the preferred embodiment to create an improved belief network that can be used as the basis for a decision support system.

Heckerman's invention depends on availability of “cases” to be fed into the generator and uses methods to modify the network such that the cases will be processed appropriately by the improved network. Once the network going through iterations of improvement cannot be improved any further, the process ends. It further lacks direct supervision and relies mainly on the assumption that content of empirical data—or cases—is robust and is a true representation of the domain.

A few other learning algorithms have also been described that use cases to construct or improve a Bayesian network and all have the same limiting assumptions and dependence on case data. Lack of supervision to improve evidence representation and structure of the network during the process is also common to most.

The invention described here, is different in approach and in methods used to evaluate and/or produce a Bayesian network. There is no use of cases and population samples are created from the data already in the networks. Next, these populations are analyzed and the observed effects 1 are quantified using a scoring system. Then all evidence in the domain is compared using the scores, based on the hypotheses and in overall domain.

The domain expert or the knowledge engineer is then presented with the report and if there are disagreements with the observed effect and design intent, then the preferred embodiment of this invention will allow for adjustments to be made by the knowledge engineer or the domain expert to reconcile the disagreement. This can be done manually, or automatically, through calculations performed by the preferred embodiment of the invention to accommodate, for example, increasing or decreasing the observed effect.

Bayesian network and influence diagram are terms used interchangeably here. The processes detailed in this document are all described for a medical Bayesian network; however, many of these processes could be applied to all Bayesian networks. The approach described here has been developed for small networks consisting of fewer than 100 nodes.

### Brief Description of Drawings

Equation 1. The formula that is used to calculate the complementary probability of state r of evidence j given absence of DXₖ

Flowchart 1. The validation process flowchart.

Flowchart 2. The modeling process flowchart.

FIG. 1. States in a node. Here states of the node “Age” are shown.

FIG. 2. The typical connections or arcs between different nodes.

FIG. 3. Comparison of two conditional probability tables in hypothesis node. If hypothesis node has a parent, then, its CPT will be different as depicted here. For each state in the parent node, probabilities of all hypotheses must be listed. If there is more than one parent, for each state of the second parent all states of the first parent must be listed which in turn include lists of all hypotheses.

FIG. 4. A Binary Frequency Table (BFT).

FIG. 5. A Complementary Frequency Table (CFT)

FIG. 6. A sample BFT generated for “PAIN_LOCATION_CA” node in an abdominal pain network used here.

FIG. 7. A sample CFT generated for “PAIN_LOCATION_CA” node in an abdominal pain network used here.

FIG. 8. BFT and CFT analysis summary for “PAIN_LOCATION_CA” and all hypotheses.

FIG. 9. The list of evidence nodes in abdominal pain network sorted in the order of decreasing significance on hypothesis “Appendicitis.”

FIG. 10. The list of evidence nodes in abdominal pain network sorted in the order of decreasing significance on the entire domain.

FIG. 11. A typical table showing a construct similar to that shown in FIG. 8 summarizing BFT analysis. This table is used for information elicitation from knowledge engineers or domain experts in order to construct a Bayesian network.

### DESCRIPTION OF A PREFERRED EMBODIMENT

The present invention relates to validation and construction of a medical Bayesian network. The following description will review methods of this invention in a computer software performing validation or construction of a medical Bayesian network. A person skilled in the art, however, would recognize that the methods and systems discussed herein will apply equally to other implementations of this invention as well as to larger Bayesian networks or non-medical Bayesian networks of same or larger sizes. It is also necessary to emphasize that a Bayesian network can have more that one node that can function as a hypothesis node. In such cases, these nodes will be analyzed one at a time. Furthermore, it may be possible to automatically identify the node or nodes that function as hypotheses nodes, by examining the structure of the Bayesian network. Flowchart 1 and Flowchart 2, depict the validation process and modeling process respectively.

In a preferred embodiment of the invention, a typical network is evaluated or constructed. A typical medical Bayesian network N includes a number of nodes, and may represent a chief complaint (primary symptom) as reported by the patient. Examples are: abdominal pain, shortness of breath, chest pain, headache, etc. Each network has at least one hypothesis node ψ={ψ₁, . . . , ψₙ} with states—or hypotheses—consisting of differential diagnoses (DDx), where ψᵢ≡Dxᵢ, i=1, 2, . . . , n. Typical diagnoses (Dx) in the list of differential diagnoses in the abdominal pain domain are appendicitis, peritonitis, lower bowel obstruction, mesenteric ischemia, ruptured ovarian cyst, etc.

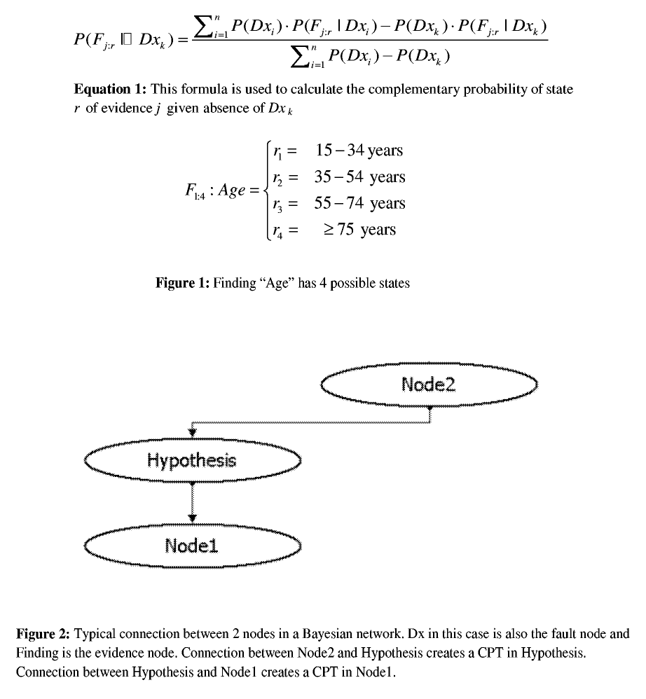

Findings provided to the network are propagated using probability calculus to ultimately determine the posterior probabilities of each Dxᵢ using values in the conditional probability tables (CPTs). Each node can have multiple states and each state may correspond to a finding. The usual mode of operation of a Bayesian network for decision support or other analysis of evidence in a domain requires a questionnaire, with each question corresponding to at least one node and each choice among the answers to the question corresponding to at least one state in a node. See FIG. 1.

Finding F_{j:r} refers to the state “r” of node Fⱼ in the Bayesian network. In the network, when it is known that an individual is over 75 years old, and node Age is designated F₁, we say finding F_{1:4} has been instantiated. See FIG. 1. A summary notation for a collection of non-sequential F_{j:r} is evidence, E={E₁, E₂, . . . , Eₙ} where Eᵢ=F_{j:r}.

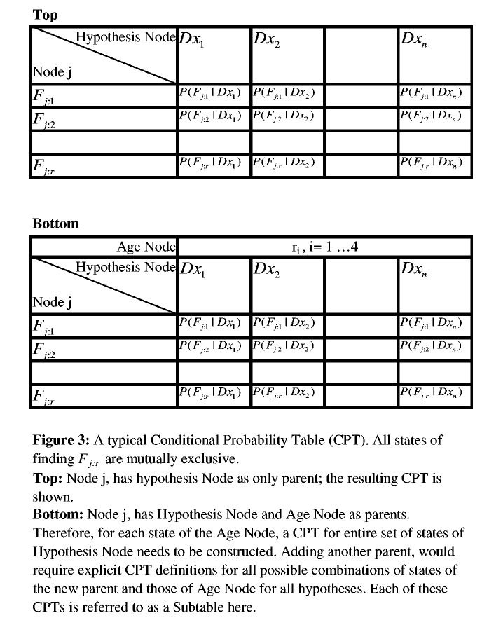

Typical connections or arcs between nodes used in developing this methodology are shown in FIG. 2. The table in CPT is filled with probabilities that appropriately describe the condition formed by the table. Top portion of FIG. 3 shows a sample table that is created in Node1 depicted in FIG. 2.

Methods for Validation

At this stage all data that is in CPTs of individual nodes is evaluated. The purpose is to organize the information captured in the CPTs in such a way that inference as to the appropriateness of numbers entered into the CPTs could be drawn. For this purpose the tables are broken down into several smaller CPTs each describing certain components of a CPT.

Certain assumptions for this step are required:
(1) Assumption 1: It is assumed that data in the CPTs represents values observed in or estimated for large samples of population for which the network is designed. For instance, in abdominal pain algorithm, data is representative of adult population in North America.
(2) Assumption 2: It is assumed that P(F_{j:r}|Dxₙ) for all Dxs represents observations in, or estimations for, similar sample populations (in terms of characteristics). These sample populations could then be combined to into a sample population that reflects the frequency of F_{j:r} in a population of prevalence—weighted Dxs (using prevalence values as found in prior probabilities in the hypothesis node).

A Bayesian network that represents a medical domain with appropriate considerations as to the nature of interaction among the evidence set in the domain should satisfy the above assumptions. The goal of the knowledge engineer and domain expert is to achieve this level and therefore these assumptions are part of the design objectives.

Methods for Validation: Step 1

In this step, the CPT of a node is used to extrapolate frequencies and create a Frequency Table (FT); this is done by multiplying prevalence-weighted probabilities of observations given a Dx such that all frequencies combined, would constitute an arbitrary population size of n (n could vary depending on the choice of user and nature of the work—100 is an arbitrary figure which seemed appropriate for use here)—see Assumption 1.

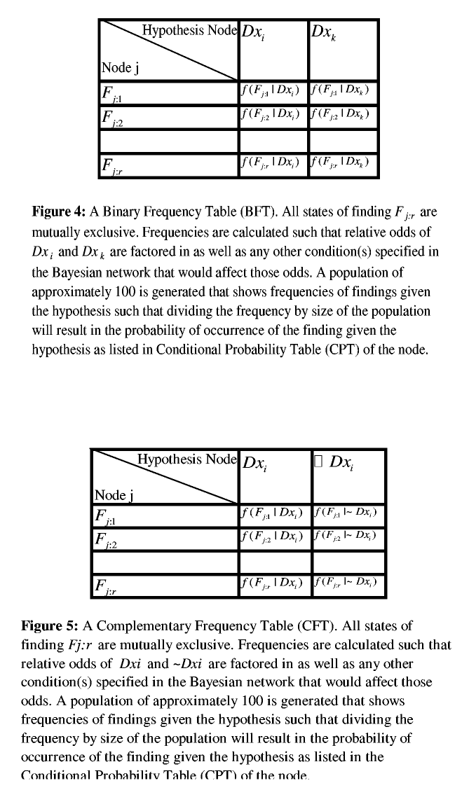

Note that this is different from simply multiplying a probability value by n. For all binary combinations of states of the hypothesis node a frequency table is derived, we will refer to these tables as Binary Frequency Tables (BFTs). In doing so, care must be exercised to ensure that frequencies describe the correct conditions as dictated by the parents of the node being analyzed. For instance, if the node being analyzed has 2 parents having 3 and 4 possible states, respectively, they will create 12 (3 times 4) possible combinations for each P(F_{j:r}|Dxₙ). Therefore, 12 CPTs are created and each must be analyzed individually. Bottom portion of FIG. 3 shows the effect of adding node Age with 4 states to a give node that has Hypothesis Node as a parent. These sets are called Subtables and analytical steps described that follow, refer to these Subtables. For a typical BFT See FIG. 4.

Methods for Validation: Step 2

In this step the complementary probabilities for any P(F_{j:r}|Dxₙ) are calculated using the CPT; this is done by adding the weighted probabilities of all of the remaining Dxs as shown in Equation 2.

As in Step 1, the probabilities for P(F_{j:r}|Dxₙ) and P(F_{j:r}|˜Dxₙ) are also converted to frequencies, we will refer to these tables as Complementary Frequency Tables (CFTs). The resulting frequencies describe the F_{j:r} in the presence and absence of Dxₙ. See FIG. 5. This step is also metaphorically referred to as “To Be or Not To Be” step, or analysis.

Methods for Validation: Step 3

In this step, all of tables created in Step 1 and Step 2 are analyzed. The states of the node that is being analyzed could represent nominal, ordinal or scale variables and therefore must be treated with respect to their variable type. In the interest of brevity, we only review nominal variables here. A person skilled in the art would recognize that there are appropriate statistical tests for each type of variable. Although more appropriate tests are available for the other 2 variable types, the tests used for nominal variables are usually appropriate for scale and ordinal variables as well.

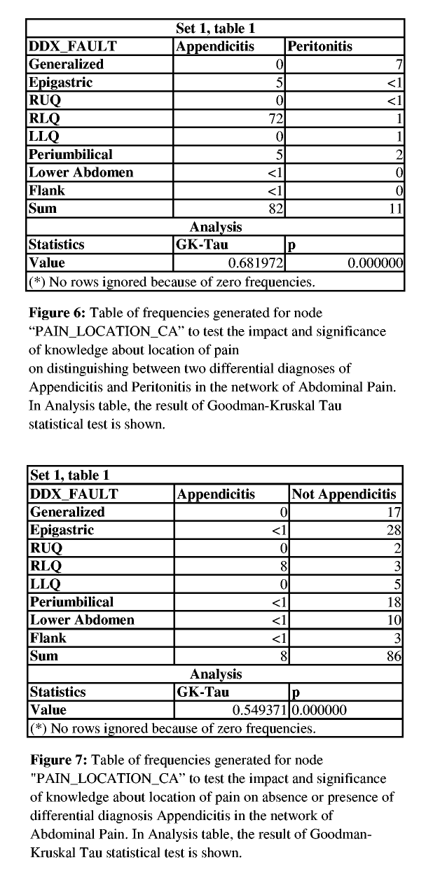

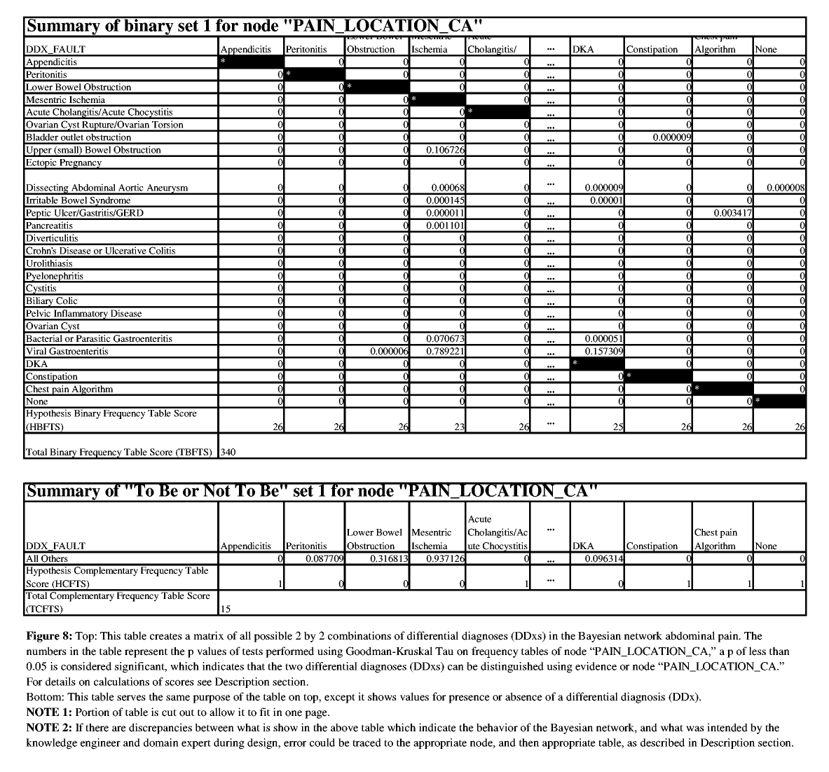

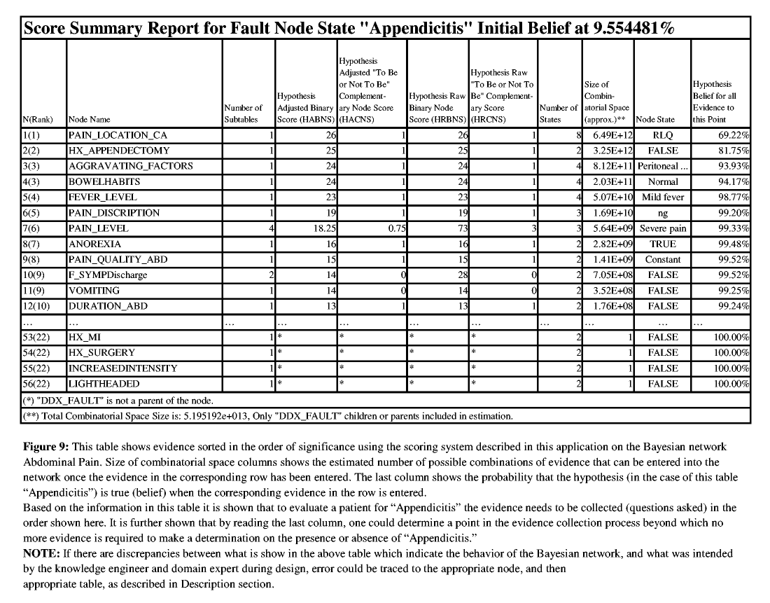

Goodman and Kruskal's Tau-b test is the most appropriate test for evaluation of frequency tables derived from the CPT of nodes in the Bayesian networks. See FIG. 6 and FIG. 7.

Methods for Validation: Step 4

In this step, analytical information from analysis of frequency tables described in Steps 1-3 is collected for all nodes that are children of hypothesis node. Data from analysis of frequency tables of Step 1 is represented in p values for comparisons of all binary combinations of states of the hypothesis node. These p values allow for comparisons of impact of a single node on differentiating two states—or hypotheses—of the hypothesis node in the case of BFTs and presence of absence of a state—or hypothesis—of the hypothesis node in the case of CFTs.

For each node analyzed in the domain, tables are constructed that summarize all p values for all BFT and CFT analyses. See FIG. 6. We refer to these tables as “Summary of BFT Analysis for Node n” and “Summary of CFT (or ‘To Be or Not To Be’) Analysis for Node n,” respectively.

A scoring system is needed to allow for comparisons of different nodes for their impact on the whole network and on the individual hypotheses. We propose one such scoring system that has 2 parts each having 6 components as follows:

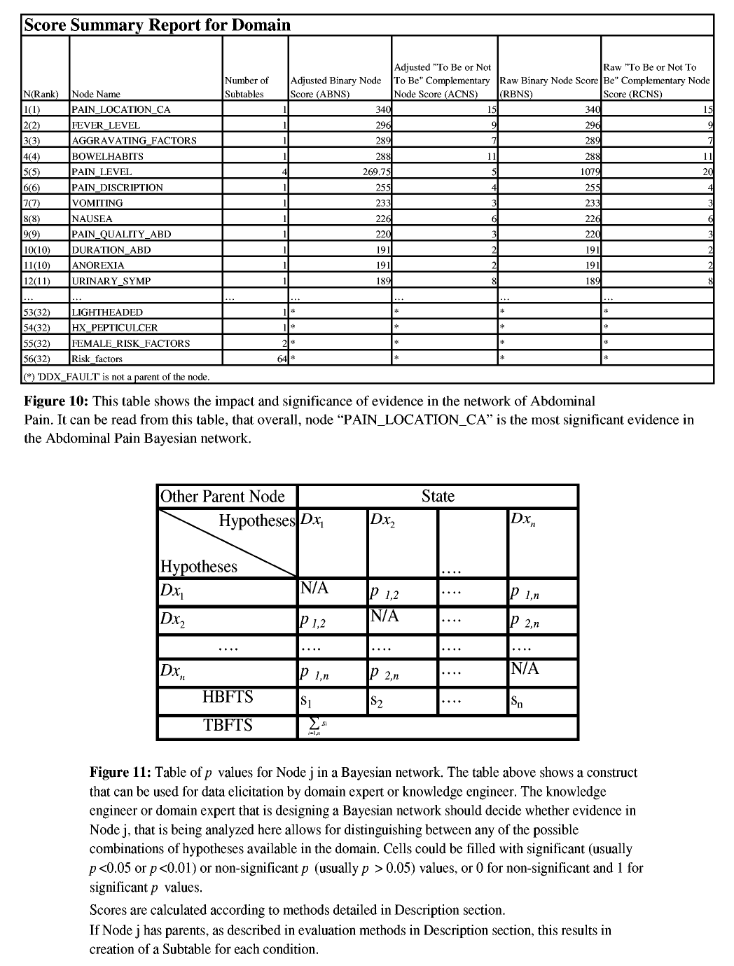

Part 1:
In BFT Analysis Summary table—See FIG. 6—for each hypothesis, a score is calculated by adding a 1 for each significant p value and a 0 for each non-significant p value. This is done for every column. This is called Hypothesis BFT Score or HBFTS.
HBFTS is described for node n, hypothesis Dxᵢ, and subtable s. See FIG. 8.
Sum of all HBFTSs derived from a single Subtable (See Step 1) of a node is designated as the Total BFT Score or TBFTS for short.
TBFTS is described for node n, and subtable s. See FIG. 8.
Sum of HBFTSs of each hypothesis from all Subtables of the node is designated as Hypothesis Raw Binary Node Score or HRBNS.
HRBNS is described for node n, hypothesis Dxᵢ. See FIG. 9.
Divided by the number of Subtables, HRBNS will give Hypothesis Adjusted Binary Node Score or HABNS.
HABNS is described for node n, hypothesis Dxᵢ. See FIG. 9.
Sum of all TBFTS (TBFTS is calculated for each Subtable) for all hypotheses is designated as Raw Binary Node Score or RBNS for short.
RBNS is described for node n. See FIG. 10.
Dividing RBNS by the number of Subtables will provide the Adjusted Binary Node Score or ABNS for short.
ABNS is described for node n. See FIG. 10.

Part 2:
In CFT Analysis Summary table—See FIG. 6—for each hypothesis in a CFT only one p value exists as each hypothesis is compared only once to a weighted sum of other possibilities. Therefore, a score of 1 is assessed for significant p values and a 0 is assessed for non-significant p values. This score is called Hypothesis CFT Score or HCFTS.
HCFTS is described for node n, hypothesis Dxᵢ, and subtable s. See FIG. 8.
As before, sum of all HCFTSs derived from a single Subtable of a node is designated as the Total CFT Score or TCFTS for short.
TCFTS is described for node n, and subtable s. See FIG. 8.
Sum of HCFTSs of each hypothesis from all Subtables of the node is designated as Hypothesis Raw Complementary Node Score or HRCNS.
HRCNS is described for node n, hypothesis Dxᵢ. See FIG. 9.
Divided by the number of Subtables, HRCNS will give Hypothesis Adjusted Complementary Node Score or HACNS.
HACNS is described for node n, hypothesis Dxᵢ. See FIG. 9.
Sum of all TCFT scores is designated as Raw Complementary Node Score or RCNS.
RCNS is described for node n. See FIG. 10.
Dividing RCNS by the number of Subtables will provide the Adjusted Complementary Node Score or ACNS.
ACNS is described for node n. See FIG. 10.
   Conditional Probability Table Analysis

Using the scoring system described above, one could evaluate the impact of numbers put in the CPT of any child of the Hypothesis node. For each Subtable, HBFTS will measure the differentiation power of numbers for any 2 hypotheses. In other words, it could show whether the numbers included in Fⱼ could distinguish between ψₘ and ψₙ. It will be up to the domain expert or the knowledge engineer to determine whether the observed effect is desired or not and to address the situation accordingly.

For certain hypotheses Fⱼ is not significantly different, ie, Fⱼ cannot be used to differentiate between them. Alternatively, for other diagnoses, Fⱼ should be able to distinguish between the two. These are effects that are not readily observable at the design time.

Using the preferred embodiment of the invention and the methodology described here, domain experts or knowledge engineers could decide whether the effects are desired. Should there be a need for change, the domain expert or knowledge engineer could easily identify the table and cell where change must be made.

In further evaluating a CPT, HCFTS could also help. This score will tell whether or not a hypothesis could be accepted or rejected based on Fⱼ. Again, this must be consistent with the intent of the domain expert or the knowledge engineer.

Using these scores and their totals for Subtables (TBTFS and TCTFS, respectively) one could compare the conditions imposed on Fⱼ. For example, if Fⱼ is also a child of node Age, the Subtables will reflect impact of Fⱼ on hypotheses for all of the age groups included in the node Age. The differences observed in the calculated scores must be consistent with the intent of the domain expert and the knowledge engineer as well as with the facts of the domain. By in-depth analyses as described in the example here, domain expert or knowledge engineer may determine that in fact node Age as parent of node being analyzed does not impact the behavior of the network and therefore such relationship is unnecessary. Such a conclusion and removal of the relationship will simplify the structure of the network.

Using these steps will provide a useful quantitative method for evaluation of the numbers is a systematic manner.

Node Analysis

Nodes could be evaluated using two different scopes. One scope is the evaluation of the impact of each node on the entire domain, and the other is the evaluation of the impact of each node on each hypothesis.

ABNS is a good estimate of the size of impact of a node on the domain, and using ACNS along with it will enable the domain expert or knowledge engineer to better judge the content the domain.

To evaluate the impact of a node on a hypothesis HABNS is used and it is complemented by HACNS.

These scores are approximations of the value of information specific to a hypothesis and specific to the domain. There are other methods that measure the value of information; however, using these scores gives consistent results with design expectations and empiric data.

The preferred embodiment of the invention using the methods described above presents the domain information in the form of ranked ordered lists of evidence associated with hypotheses. And as such, the user can transparently visualize the behavior of the Bayesian network. See FIGS. 8, 9 and 10. A consequence of this method of visualization is that the user can enhance the model and change it according to his or her belief of the order of associations and their strengths.

Modeling a Bayesian Network

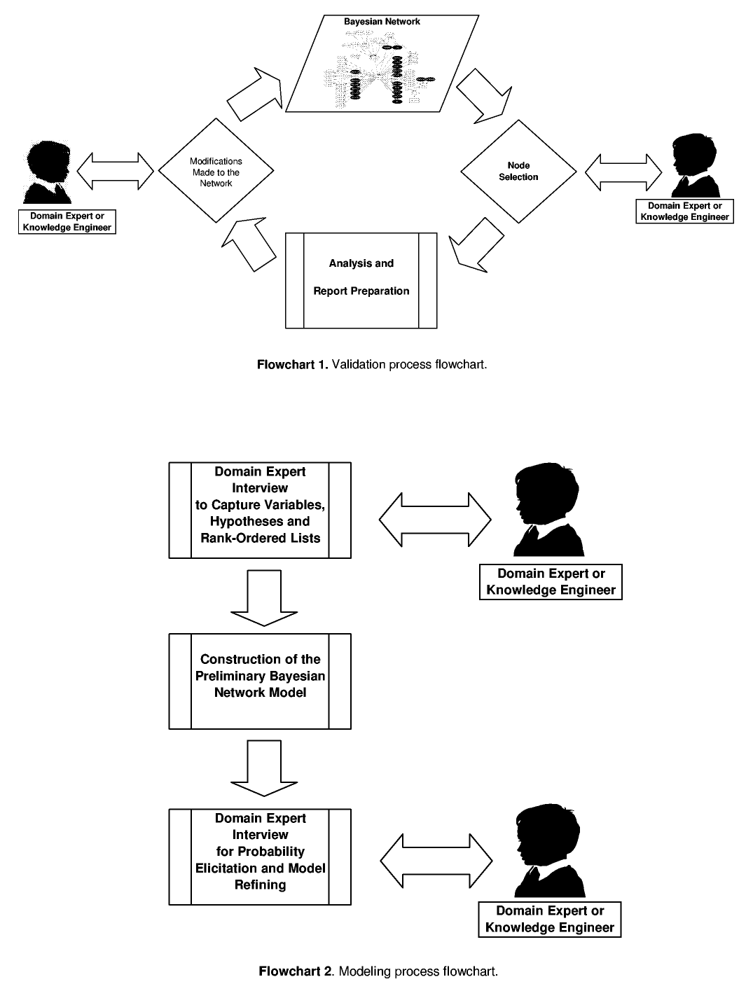

At this point, having analyzed the nodes that construct a Bayesian network for evaluation and validation of information within the nodes, we can argue that the reverse of this process could help simplify the construction of a Bayesian network. The preferred embodiment of the invention helps modeling a domain in the form of a Bayesian network by eliciting information about the domain as follows:
(1) Identify the subject of the domain and hypotheses that need to be analyzed
(2) Identify the evidence that need to be collected in the domain, create nodes for the evidence and create states in each node for each state of the evidence. For example fever node with states, mild, moderate, high, absent.
(3) Classify evidence into categories of sign, symptom, laboratory and risk factors. Almost always, it is best to set up nodes for evidence that is of category sign, symptom, and laboratory as children of hypothesis node. Risk factors, at times must be created as parents of the hypothesis node.
(4) Determine whether any evidence in the domain must be listed as a parent of any of the nodes in the categories sign, symptom, and laboratory. If so, as discussed previously, Subtables will be created.
(5) Construct the lay out of the Bayesian network using the information elicited from the domain expert or knowledge engineer.
(6) Construct tables of the association of each evidence in the domain for all binary and complimentary combinations of domain hypotheses; this is a construct similar to FIG. 8 and is shown in FIG. 11.
(7) Prompt the user to fill out these tables with his/her belief of whether or not the evidence can help discriminate the 2 hypotheses or include/exclude one.
(8) Construct tables similar the ones in FIG. 9 (for each node and hypothesis) and FIG. 10 (for the entire domain).
(9) Prompt the user to modify the rank ordered list, in case of each modification the user must decide which of the cells in the table shown in FIG. 11, is needs to be modified to accommodate change.
(10) Once the ordered lists are finalized, the user will be prompted to fill out frequency tables for all binary combinations of hypotheses. The frequency tables can be analyzed at design time to determine whether or not they accommodate values reflected in the table show in FIG. 11.

Structural construction and CPT data entry in the format laid out above, will provide the user with tangible objective to accomplish and provides instant feed back as whether or not the user (knowledge engineer or domain expert) has accomplished his/her objective.

Conclusion, Ramifications, and Scope

Accordingly, the reader will see that the methods described in the invention provide a highly reliable and accurate tool for validation and evaluation of behavior of a Bayesian network. Using these methods, it is not necessary to test all possible combinations of observations in a Bayesian network. Also, using these methods, if an aberrant behavior is identified, it could quickly be traced to the problematic cell in the table in question. This saves time and provides a consistent and reproducible approach to troubleshooting. Additionally, using methods described here, a new Bayesian network can be constructed from scratch that would explicitly include design intentions in a structured fashion. This new network can be improved upon by the knowledge engineer or the domain expert, and by relying on validation methods described here, real-time evaluation during design can be provided to the designer.

While the above description contains many specificities, these should not be construed as limitations on the scope of the invention, but rather as an exemplification of one preferred embodiment thereof. For example, a non-medical Bayesian network that models a domain could be evaluated in the same manner as described above. Or, there can be other variation of the scoring system proposed, with a similar end goal, namely to measure the impact or significance of observed effects in comparison to other observations.

While the invention has been described in the context of a preferred embodiment, it will be apparent to those skilled in the art that the present invention may be modified in numerous ways and may assume many embodiments other than that specifically set out and described above. Accordingly, it is intended by the appended claims to cover all modifications of the invention which fall within the true scope of the invention.

What is claimed is:

1. A method for validation of a Bayesian network comprising:
a) preparing a list of hypotheses extracted from a user-selected node in said Bayesian network;
b) preparing a list of evidence nodes and their states in said Bayesian network;
c) extracting conditional probability tables in said Bayesian network;
d) using said conditional probability tables of said Bayesian network to construct a corresponding frequency table;
e) performing numerical, statistical, probabilistic, and logical analyses of said nodes using said probability tables and said frequency tables for a plurality of combinations of 2 of said hypotheses as well as combinations of presence vs. absence of said hypotheses;
f) providing quantitative representation of results of said analyses of said nodes with respect to said hypotheses;
g) providing quantitative representation of results of said analyses of said nodes with respect to said Bayesian network
h) providing quantitative representation of results of said analyses of said nodes with respect to remaining of said nodes in said Bayesian network;
whereby said method is used to examine, evaluate, understand, and predict behavior of said Bayesian network and to make corrections to structure of said Bayesian network or to make corrections to said probability tables of said Bayesian network.

2. The method for validation of claim 1, where in: said hypothesis node is automatically identified.

3. The method for validation of claim 1, where in: said Bayesian network has more than one hypothesis node.

4. The method for validation of claim 1, where in: probability calculus is used to satisfy a specified condition imposed on a node in said Bayesian network prior to analysis of said node.

5. The method for validation of claim 1, where in: a plurality of appropriate statistical methods is used to determine significance and strength of interactions between different states of said nodes and said hypotheses.

6. The method for validation of claim 1, where in: said analyses are used to determine whether content of said nodes correctly or appropriately describe interaction between said hypotheses.

7. The method for validation of claim 1, where in: said analyses can be used to determine whether content of said nodes correctly or appropriately describe interaction between presence vs. absence of said hypotheses.

8. The method for validation of claim 1, where in: said analyses are used to determine whether information relevant to said hypotheses is correctly represented in said Bayesian network.

9. The method for validation of claim 1, where in: a scoring system is used for said quantitative representations to quantify impact and significance of the evidence in said Bayesian network.

10. The method for validation of claim 1, where in: said quantitative representations measure impact or significance of said nodes given one of said hypotheses.

11. The method for validation of claim 1, where in: said quantitative representations measure impact and significance of said nodes given none of said hypotheses.

12. The method for validation of claim 1, where in: said quantitative representations identify disagreement between design intention and behavior of said Bayesian network and, by back-tracking generation process of said quantitative representations, faulty cells in said probability tables are identified.

13. A method for modeling of a Bayesian network comprising:
a) preparing a list of hypotheses that are of interest in a domain;
b) preparing a list of evidence or variables that are related to said hypotheses;
c) constructing a preliminary model of a Bayesian network that provides one hypothesis node including said hypotheses as states;
d) adding evidence nodes for said variables to said preliminary Bayesian network model and connecting said hypothesis node as parent of said evidence nodes;
e) preparing blank conditional probability tables for said hypothesis node and said evidence nodes;
f) preparing lists of said evidence with respect to each of said hypotheses in order of strength of impact or association;
g) preparing lists of said hypotheses with respect to each of said evidence in order of probability;
h) preparing list of said hypotheses in order of probability prior to knowledge of any of said evidence;
i) filling said conditional probability tables to reflect information captured in said lists using mathematical approximations of probability values required for compliance with said lists.

14. The method for modeling of claim 13, where in: said lists are constructed through interaction by domain expert or knowledge engineer or individual sufficiently skilled in subject.

15. The method for modeling of claim 13, where in: said lists are constructed through by accessing prior knowledge of said domain in a knowledgebase, electronic, computerized or otherwise.

16. The method for modeling of claim 13, where in: said lists also reflect belief of said hypotheses given different states of said evidence nodes.

17. The method for modeling of claim 13, where in: the method for validation of claim 1 is used to provide real-time validation of said model.
